(19) United States
(12) Patent Application Publication
(10) Pub. No.: US 2026/0119965 A1
(43) Pub. Date: Apr. 30, 2026

(54) METHOD AND SYSTEM FOR AI-BASED QUANTIFYING SYSTEM LEVELS OF SUPPORT PROCESSING

(71) Applicant: Ronald Waiian Townsen, Austin, TX (US)

(72) Inventor: Ronald Waiian Townsen, Austin, TX (US)

(21) Appl. No.: 18/925,529

(22) Filed: Oct. 24, 2024

(51) Int. Cl. G06N 20/00

(52) U.S. Cl. CPC G06N 20/00

(57) ABSTRACT

A system for an automated Quantifying System Levels of Support (QSLS) processing based on target system requirements data including a processor of a QSLS server node configured to host a machine learning (ML) module coupled to at least one user-entity node and a plurality of designer nodes over a network and a memory on which are stored machine-readable instructions that when executed by the processor, cause the processor to: acquire a user system architecture request containing conceptual system architecture data associated with the target system requirements including architecture mechanisms and a plurality of architecture view points from the at least one user-entity node; parse the user system architecture request to extract a plurality of key classifying features; query a local database to retrieve local historical system architecture's correlation sets-related data based on the plurality of key classifying features; generate at least one classifier feature vector based on the plurality of the key classifying architecture mechanism features and the local historical system architecture's correlation sets-related data; provide the at least one classifier feature vector to the ML module configured to generate an architecture predictive model for producing at least one architecture viewpoint-based parameter; and ingest the at least one architecture viewpoint-based parameter into an architecture correlation model configured to output a plurality of design correlation parameters for level of support of the architecture mechanisms of a given viewpoint from the plurality of the architecture viewpoints.

### FIELD OF DISCLOSURE

The present disclosure generally relates to system design applications, and more particularly, to an AI-based automated system and method for real-time quantifying system levels of support based on requested system architecture data.

### BACKGROUND

System architecture plays a pivotal role in shaping the design, functionality, and performance of complex systems. As organizations strive for robust, scalable, and efficient solutions, understanding architectural principles becomes paramount. It is critical, from architectural mechanisms'standpoint, to quantify design attributes based on system architecture that leads to successful system designs and implementations.

The problem exists in measuring a system architecture or system of system architecture is that the system (or system-of-systems) and architectural quality attributes along with business drivers are different concepts from architectural mechanisms. The problem of measuring system architecture is in the complexly of comparing relatable terms in such a way as to compute values which can represent level of support.

Conventional modeling of mechanism relationships tools (such as UAF or TOGAF®) only provide qualitative relationships for architectures, but provide no quantitative measurements for how the mechanisms and standards being applied support system characteristics, quality attributes and business drivers. Existing methods provide no quantitative measurements to support the design, but rely on architect's best estimate of how well the architecture meets the customer needs based on history and experience. None of the existing method employ AI-based predictive analytics of the system architecture data.

Accordingly, a system and method for AI-based real-time quantifying levels of support based on requested system architecture data are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for system for an automated Quantifying System Levels of Support (QSLS) processing based on target system requirements data including a processor of a QSLS server node configured to host a machine learning (ML) module coupled to at least one user-entity node and a plurality of designer nodes over a network and a memory on which are stored machine-readable instructions that when executed by the processor, cause the processor to: acquire a user system architecture request containing conceptual system architecture data associated with the target system requirements including architecture mechanisms and a plurality of architecture view points from the at least one user-entity node; parse the user system architecture request to extract a plurality of key classifying features; query a local database to retrieve local historical system architecture's correlation sets-related data based on the plurality of key classifying features; generate at least one classifier feature vector based on the plurality of the key classifying architecture mechanism features and the local historical system architecture's correlation sets-related data; provide the at least one classifier feature vector to the ML module configured to generate an architecture predictive model for producing at least one architecture viewpoint-based parameter; and ingest the at least one architecture viewpoint-based parameter into an architecture correlation model configured to output a plurality of design correlation parameters for level of support of the architecture mechanisms of a given viewpoint from the plurality of the architecture viewpoints.

Another embodiment of the present disclosure provides a method that includes one or more of: acquiring a user system architecture request containing conceptual system architecture data associated with the target system requirements including architecture mechanisms and a plurality of architecture view points from the at least one user-entity node; parsing the user system architecture request to extract a plurality of key classifying features; querying a local database to retrieve local historical system architecture's correlation sets-related data based on the plurality of key classifying features; generating at least one classifier feature vector based on the plurality of the key classifying architecture mechanism features and the local historical system architecture's correlation sets-related data; providing the at least one classifier feature vector to the ML module configured to generate an architecture predictive model for producing at least one architecture viewpoint-based parameter; and ingesting the at least one architecture viewpoint-based parameter into an architecture correlation model configured to output a plurality of design correlation parameters for level of support of the architecture mechanisms of a given viewpoint from the plurality of the architecture viewpoints.

Another embodiment of the present disclosure provides a computer-readable medium including instructions for: acquiring a user system architecture request containing conceptual system architecture data associated with the target system requirements including architecture mechanisms and a plurality of architecture view points from the at least one user-entity node; parsing the user system architecture request to extract a plurality of key classifying features; querying a local database to retrieve local historical system architecture's correlation sets-related data based on the plurality of key classifying features; generating at least one classifier feature vector based on the plurality of the key classifying architecture mechanism features and the local historical system architecture's correlation sets-related data; providing the at least one classifier feature vector to the ML module configured to generate an architecture predictive model for producing at least one architecture viewpoint-based parameter; and ingesting the at least one architecture viewpoint-based parameter into an architecture correlation model configured to output a plurality of design correlation parameters for level of support of the architecture mechanisms of a given viewpoint from the plurality of the architecture viewpoints.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a network diagram of a system for an AI-based real-time quantifying levels of support based on requested system architecture data consistent with the present disclosure;

FIG. 2 illustrates a network diagram of a system for an AI-based real-time quantifying levels of support based on requested system architecture data implemented over a blockchain network consistent with the present disclosure;

FIG. 3 illustrates a network diagram of a system including detailed features of a Quantifying System Levels of Support (QSLS) Server node consistent with the present disclosure;

FIG. 4 illustrates a flowchart of a method for an AI-based real-time quantifying levels of support based on requested system architecture data consistent with the present disclosure;

FIG. 5 illustrates a further flowchart of a method for an AI-based real-time quantifying levels of support based on requested system architecture data consistent with the present disclosure;

FIG. 6 illustrates deployment of a machine learning model for prediction of design correlation parameters using blockchain assets consistent with the present disclosure;

FIG. 7 illustrates a block diagram of a system including a computing device for performing the method of FIGS. 4 and 5.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 37 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of the predictive architecture-to-design correlation model configured to output a plurality of design correlation parameters, embodiments of the present disclosure are not limited to use only in this context.

The following definitions may be used.

“Quantifying System Levels of Support (QSLS)”: A methodology that uses mathematical models and AI-driven analysis to quantitatively assess how well a system architecture, design, or implementation supports specified characteristics, quality attributes, and business drivers. It provides numerical values (typically between 0 and 1) indicating the degree of support for each assessed factor.

“Architecture mechanisms”: Fundamental design patterns, strategies, or approaches used at the system architecture level to address specific quality attributes or functional requirements. Examples include load balancing, caching, and microservices architecture.

“Architecture view points”: Specific perspectives or lenses through which a system architecture is examined and evaluated. Common viewpoints include functional, structural, behavioral, and deployment perspectives. Each viewpoint focuses on particular aspects of the system architecture.

“Key classifying features”: Essential characteristics or attributes extracted from the system architecture request that are used to categorize, analyze, and evaluate the proposed system. These may include system type, primary functions, scale, and critical quality requirements.

“Classifier feature vector”: A mathematical representation of the key classifying features, typically in the form of an n-dimensional vector where each dimension corresponds to a specific feature. This vector is used as input for machine learning algorithms to categorize or analyze the system architecture.

“Architecture predictive model”: A machine learning model trained on historical architecture data to predict various outcomes or characteristics of a proposed system architecture and design. This model takes the classifier feature vector as input and outputs predictions about system performance, quality attributes, or potential issues.

“Architecture correlation model”: A mathematical model that establishes relationships between different aspects of system architecture, such as how specific architecture mechanisms correlate with quality attributes or business drivers. It uses matrices of correlation coefficients to quantify these relationships.

“Level of Support”: A numerical value, typically between 0 and 1, that quantifies how well a particular aspect of the system (e.g., an architecture mechanism) supports a specific quality attribute, characteristic, or business driver. A value of 0 indicates no support, while 1 indicates maximum support.

“Design correlation parameters”: Numerical values that represent the strength of relationships between design elements and various system qualities or requirements. These parameters are derived from the architecture correlation model but are more specific to the design level.

“Implementation correlation parameters”: Similar to design correlation parameters, but specific to the implementation level. These values quantify how implementation decisions relate to system qualities and requirements.

“Pre-set threshold value”: A predetermined numerical value used as a decision boundary for triggering actions or alerts in the QSLS system. This value is set based on historical data, expert knowledge, or specific project requirements.

“QSLS metrics”: A set of quantitative measurements produced by the QSLS methodology, including but not limited to Levels of Support for various quality attributes, characteristics and business drivers. In addition, correlation values between architecture mechanisms and system characteristics, and predictive scores for system performance or risk.

The following describes the notation used to represent Matrices, Vectors and Correlation of different concepts. Correlation is based on a linguistic correlation of the definitions of the various concepts involved.

[Xi, Yj]=This notation identifies a nodal point in a two-dimensional matrix of X and Y.

[Xi]=This notation identifies a nodal point in a one-dimensional matrix also known as a vector.

C(XiYj)=The linguistic correlation of point Xi and Yj respectively19

In one embodiment, for Architectural analysis, the correlation is executed based on linguistic based textual descriptions of the two terms and using Artificial Intelligence to compute a linguistic correlation between the terms.20

In one embodiment, the process used by AI to compute Linguistic Correlations is as follows:
[C(XiYj)]=A two-dimensional matrix of linguistic correlations of X and Y
{ }=Indicates a Set or List of informational objects which is another way of showing a vector.

### Working Constants

NAM—Number of Selected Architectural Mechanisms (number of entries in the vector VAMW)

NAPC—Number of defined Architectural Mechanism Part Components

NC—Number of defined Architectural Characteristics

NSAi—Number of Characteristic System Attributes supporting Architectural Characteristic ACi. Architectural Characteristics can breakdown in to a varying number of System Attributes.

NVSACSA—Number of entries in the VSACSA vector (also number of columns in the MR-APC-ACSA matrix and rows in the MR-ACSA-AQASA matrix). This constant is defined by the number of Coherence System Attributes selected, defined and used in the QSLS Book of Knowledge.

NQA—Number of Architectural Quality Attributes

NQASAi=Number of Quality Attributes Sub-Attributes supporting Quality Attribute AQAi Architectural Quality Attributes can have a varying number of Sub-Attributes.

NVSQASA—Number of entries in the VSQASA vector (also number of columns in the MR-ACSA-AQASA matrix and rows in the MR-AQASA-BD matrix). This constant is defined by the number of Quality Attribute Sub-Attributes selected, defined and used in the QSLS Book of Knowledge.

NVSQASA′=A normalization constant accounting for Customer ranking of Quality Attributes in computing Business Driver support levels.

NVSoSQASA=Number of Systems defined for a System of Systems in the VSoSQASA vector.

Copyright© 2024 All rights reserved. Except as permitted under the U.S. Copyright Act of 1976, no part of this publication may be reproduced, distributed or transmitted in any form or by any means or stored on a database or retrieval system, without the prior written permission of the author.

NVSoSQASA′=Adjusted Normalization constant accounting for Customer ranking of Quality Attributes in computing Business Driver support levels.

NormSoSW=A normalization constant to deal with System Weights chosen for a System of Systems Architecture.

### Working Sets/Vectors/Matrix

{AMW1,AMW2,AMW3, . . . }=Indicates a list of selected Architectural Mechanism Weights for the System Architecture. The basic weights are derived by a linguistic correlation between the definition of the System Architectural Mechanism and the Architecture Viewpoint.

The Architectural Viewpoints are selected views into the Architecture to understand its relevance and how the Architecture looks from different points of view. Typical Viewpoints are Functional, Logical, Operational, etc. Thus, the Mechanism weights vary with the Architectural Viewpoint chosen for analysis. VAMW=[AMWi]={AMW1,AMW2,AMW3, . . . }

{QASAW1, QASAW2, QASAW3, . . . }=Indicates a list of desired Quality Attribute Sub-Attribute Weights indicating the importance of Quality Attribute Sub-Attribute to the current customer focus. This information is typically provided as a ranking of Quality Attributes by the customer involved in receiving the Business Driver results; where the ranking (1 to N where 1 means most important and N is least important) is converted to a weight using the equation: QASAWi=(Maximum Quality Attribute Sub-Attribute Ranking−Quality Attribute Sub-Attribute(i)+1)/(Maximum Quality Attribute Sub-Attribute Ranking)

VQASAW={QASAW1, QASAW2, QASAW3, . . . }=[QASAWi]

{SBD1, SBD2,SBD3, . . . }=The output solution set of Solution Business Driver levels of support (0 to 1) for System Architecture. VSBD={SBD1, SBD2,SBD3, . . . }=[SBDi]

{SQASA11,SQASA12,SQASA13, . . . }=The output Solution Set of Quality Attribute Sub-Attribute values of support for the System Architecture. This output is a value between 0 and 1 where 0 means no support and 1 is a measure of maximum support. VSQASA={SQASA11, SQASA12,SQASA13, . . . }=[SAQASAi]

{SQASAn1, SQASAn2, SQASAn3, . . . }=The set of Architectural Quality Attribute Sub-Attributes for Architectural Quality Attribute QAn. This set/vector is created by extracting the subset of information from the VSQASA vector/set. VSQASAnSubVector={SQASAn1,SQASAn2,SQASAn3, . . . }=[SQASAni]

In support and used with VSQASAnSubVector, a VSQASAWnSubVector vector provides the amount of support of each SQASA is weighted to allow for 100% combination to QAn.

{SACSA11,SACSA12,SACSA13, . . . }=The output Solution Set of Architectural Characteristic System Attribute values for a set of Architectural Characteristics. The values define support (1 is a measure of maximum support). Embedded within the set VSACSA={SACSA11,SACSA12,SQASA13, . . . }=[SACASAi]

VSACSA′={(SACSA11*QASAW11), (SACSA12*QASAW12), . . . }=[SACASAi*QASAWi]

{ACSAn1, ACSAn2,ACSAn3, . . . }=The set of Architectural Characteristic System Attributes for Architectural Characteristic CAn. This set/vector is created by extracting the subset of information from the VSACSA vector/set. VSACSAnSubVector={SACSAn1,SACSAn2,SACSAn3, . . . }=[SACSAni]

In support and used with VSACSAnSubVector, a VSACSAWnSubVector vector provides the amount of support of each SACSA is weighted to allow for 100% combination to CAn.

{SAPC 1,SAPC2,SAPC3, . . . }=The output Solution Set of Architectural Part Component values of support for the System Architecture. This output is a value between 0 and 1 where 0 means no support and 1 is a measure of maximum support. VSAPC={SAPC1,SAPC2,SAPC3, . . . }=[SAPCi]

{QASAR1,QASAR2,QASR3 . . . }=A set of customer based Rankings of the importance of each of the Quality Attribute Sub-Attributes. We can then change the Rankings (1 to N) to a Weight Value for use: QASAWn=(Maximum(Rankings)−Rankingn+1)/Maximum(Rankings)

VQASAW={QASAW1,QASAW2,QASAW3, . . . }

MSoSCSA=Matrix built by using the output vectors of Solution of Characteristic System Attributes (VSACSA) of the individual systems in a System of Systems. The output matrix will be of size N by NVSACSA where N is the number of systems in the System of Systems. MSoSCSA={VSACSAs1, VSACSAs2, . . . }

Working Reference Matrices may be used as follows.

Matrices are developed for the QSLS Book of Knowledge using AI to build linguistic based correlations.

The process of computing linguistic correlations by AI is discussed herein. These matrices can be updated for new information as needed.

MR-AM-APC=[C(AMi APCj)]13 a two-dimensional matrix capturing the correlations between Architectural Mechanism concepts and Architectural Part Component concepts. This matrix provides a measure of how well each of the Part Components relate to the Architectural Mechanism and covers all Part Components and all Mechanisms which have been selected as supporting the desired System Architecture. This matrix is built from a general matrix MR-AM-APCPRIME which contains all currently identified Mechanisms and Mechanism Part Components from the Book of Knowledge.

MR-APC-ACSA=[C(APCj ACSAk)]—a two-dimensional matrix capturing the correlations between Architectural Part Component concepts and Architectural Characteristic System.

Attribute concepts. This matrix provides a measure of how well each of the Part Components relate to the Architectural Characteristic System Attributes and covers all Part Components and all Architectural Characteristic System Attributes.

MR-ACSA-AQASA=[C(ACSAk AQASAm)]—a two-dimensional matrix capturing the correlations between Architectural Characteristic System Attributes concepts and Architectural Quality Attribute Sub-Attribute concepts. This matrix provides a measure of how well each of the Architectural Characteristic System Attributes concepts relate to the Architectural Quality Attribute Sub-Attribute concepts.

MR-AQASA-BD=[C(AQASAm BDn)]—a two-dimensional matrix capturing the correlations between Architectural Quality Attribute Sub-Attribute concepts and Business Driver concepts. This matrix provides a measure of how well each of the Architectural Quality Attribute Sub-Attribute concepts relate to the Business Driver concepts.

In one embodiment, computing and predicting levels of support for s system architecture is implemented as follows. The System Architecture is defined by a set of Architecture Mechanisms:
SA=[AMi]

The Development of QSLS identified that the relationships needed to be computed consistently across the lower levels and that the higher levels (Mechanisms, Characteristics, Quality Attributes) are just a reflection of lower-level detailed relationships. In QSLS, the relationships are built through the use of cross-correlation matrices which act as filters to compute the different areas of relationships. The cross-correlation matrices are developed using the power of AI to correlate linguistic information to give a level of relationship between different terms.

To deal with computing a level of support for the System Architecture, one needs to begin with understanding how the Architectural Mechanisms relate to the System. In the exemplary embodiments, a weight is assigned to each Architectural Mechanism (0 to 1 where 1 means it fully supports the System Architecture and less than 1 means it has less impact on the System Architecture). This now creates a set/vector to describe a relationship between the Architectural Mechanism concepts and the System Architecture Viewpoint:
SA=[AMWi]

The set/vector of Architecture Mechanism weights are values relative to a “Viewpoint”. The weights in the vector represent how the different mechanisms relate to the Viewpoint under analysis. The Mechanism weights are generated by computing the linguistic correlation (0 to 1) between the selected Viewpoint and the Mechanism description. Each viewpoint drives how the Mechanism relates (Examples):

System Structure Support: a high-level perspective on the overall organization, composition, and relationships between the major components and subsystems that make up a system.

Security: Describes the security aspects of the system.

Functional: Describes the system's functional elements.

Computing architecture part component vector is implemented as follows.

The QSLS Book of Knowledge contains a matrix of correlations of Architectural Mechanisms and Architectural Mechanism Part Components (MR-AM-APCPRIME). The working matrix (MR-AM-APC) is created by selecting only those Architectural Mechanisms which relate to the System Architecture (Architect choice). From the down selected matrix (MR-AM-APC), one can build four different working Part Component vectors through the matrix math of:

$$VSAPCAVG = ( VAMW * MR - AM - APC )$$

Note that in the computation, the summation of each column against the vector entry is normalized by 1/N of the active elements for an average output of the computation. The Sparse Matrix Math is used to provide an average effect for the selected Architecture mechanisms by averaging only the active elements of the sparse matrix.

In one embodiment, bounds on the Part Component data may be determined by looking at Minimum and Maximum of each Part Component and normalizing by the VAMW data. Normalization for the Minimum and Maximum and Median is not required since the values are selected from the matrix as opposed to executing full matrix multiplication, but note that both input vector and matrix nodes can be filtered depending on settings.

Where VSAPCmax=Max({AMWi*APCij, . . . }) is the maximum across each Architectural Part Component for the selected Mechanisms in the MRAM-APC matrix and across all the Architectural Part Components.

Where VSAPCmin=Min({AMWi*APCij . . . }) is the minimum across each Architectural Part Component for the selected Mechanisms in the MRAM-APC matrix and across all the Architectural Part Components.

Where VSAPCmed=Median({AMWi*APCij . . . }) is the median across each Architectural Part Component for the selected Mechanisms in the MRAM-APC matrix and across all the Architectural Part Components. The median is used because the distribution of values across the column of the matrix is not assumed to be a normal distribution of values.

The disclosed application may now build the following calculations for Minimums, Maximums, Median and Average outputs for Characteristics, Quality Attributes and Business Drivers. However, the computations for the Average vector are presented herein, while the same math holds for Minimum and Maximum and Median.

Computing characteristic support levels for system architecture may be implemented as follows. Using the Correlation matrix of Part Components against Characteristic System Attributes (MR-APC-ACSA) provided in QSLS Book of Knowledge, the application can compute a solution vector for the Characteristic System Attributes support levels. Note that this computation as well as the following matrix/vector computations of Characteristics, Quality Attributes and Business Drives can be viewed as a form of filter translation between different dimensions of the data.

$$VSACSA = ( VSAPC * MR - APC - ACSA )$$

The vector matrix math (used for Characteristics, Quality Attributes and Business Driver) uses a summation of all the row nodes (greater than 0) for a column to normalize the cross multiplication of the vector with the matrix. The process is done in place of a simple average since all values within the column are between 1 and 0 and the input vector is or range 0 to 1. The process allows the output of the cross multiplication to be normalized to account for the variance across the column and produce a value which is normalized such that the value can represent a non-biased measure of the possible outcome.

The resulting vector can map to a set-of-sets of Architectural Characteristic System Attributes. One can separate the set of System Attributes for each Characteristic into its own vector VSQASAnSubVector which can be used to compute the Architectural Characteristic ACn:

$$ACn = ( VSACSAnSubVector * VSACSAWnSubVector )$$

Computing Quality Attribute support levels for System Architecture may be implemented as follows.

Using the QSLS Book of Knowledge Correlation matrix of Characteristic System Attributes vs. Quality Attribute Sub-Attributes (MR-ACSA-AQASA), one can compute a solution vector for the System Quality Attribute Sub-Attribute support levels:

$$VSQASA = ( VSACSA * MR - ACSA - AQASA )$$

The resulting vector can map to a set-of-sets of Architectural Quality Attribute Sub-Attributes. We can separate the set of Sub-Attributes for each Quality Attribute into its own vector VSQASAnSubVector which can be used to compute the Architectural Quality Attribute AQAn:

$$AQAn = ( VSQASAnSubVector * VSQASAWnSubVector )$$

Computing Business Driver level support for System Architecture may be implemented as follows.

Dealing with a customer, they can provide a focus on what Quality Attributes they have key interest in. The disclosed embodiments can accommodate their interest by altering the VSQASA vector by weighting the individual elements using the values of the Quality Attribute Sub-Attribute weight set {QASAW1,QASAW2,QASAW3, . . . }

$${VSQASA}^{′} = \{ ( SQASA 1 * QASAW 1 ) , ( SQASA 2 * QASAW 2 ) , … \}$$

Using the QSLS Book of Knowledge Correlation matrix of Quality Attribute Sub-Attributes vs. Business Drivers (MR-AQASA-BD), one can compute a solution vector for the System Business Driver support levels (using either the original or prime version of VSQASA). Note that support for a Business Driver ranges from 0 (no support) to 1 (fully supports).

$$VSBD = VSQASA * MR - AQASA - BD )$$

$${NVSoSQASA}^{′} = \sum SQASAi * QASAWi$$

$${VSBD}^{′} = ( {VSQASA}^{′} * MR - AQASA - BD )$$

The disclosed embodiments do not need to group the Business Drivers, so we do not need to move from the vector to a grouped vector solution as we do for Characteristics and Quality Attributes.

As the customer's program evolves, their focus (ranking) of Quality Attributes may evolve as well. The application can adjust the VSQASA vector to deal with the changing desires and understand how well the System supports the various Business Drivers accordingly based on customer changing focus.

Computing values for a system of systems may be implemented as follows.

A System-of-Systems can be considered as a set of Systems which create a System-of-Systems.

$$ASoS = \{ SW 1 ( AS 1 ) , SW 2 ( AS 2 ) , … \}$$

Where:

ASoS=Architectural System-of-Systems is a concept which once created can be considered static in nature. While it contains Dynamic capabilities at the Design level, the Architecture is static in nature.

SWi=a function applied to a System which describes and captures:

The relationship between how the System is used in the System-of-Systems Architecture and how the System is designed. This is because while a System is a static concept independent of its use, only some of the System may be relevant to the System-of-Systems Architecture. Note that SW results in an ordered set of Systems weights based on the importance of the system to the System-of-Systems.

Importance of Architectural System ASi usage within the System-of-Systems Architecture is discussed herein.

To understand the Architectural Quality Attributes of a System-of-Systems, one needs to look at the related Architectural Quality Attributes of the individual Systems comprising the System-of-Systems.

A Vector of the Importance of each System to the System of Systems (values range from 1 to 0) may be created:

$$VSW = \{ SW 1 , SW 2 , … \}$$

If combined with the matrix MSoSCSA made up of VSACSA (Vector of Characteristic System Attributes for each system) and can be shown as a set:

$$MSoSCSA = \{ VSACSAS 1 , VSACSAS 2 … \}$$

$$VSoSCSA = ( VSW * MSoSCSA )$$

Which is a combined Characteristic System Attributes vector of the systems involved in the System of Systems.

Now this vector (VSosSCSA) may be used to compute Quality Attributes and Business Drivers using the same math approach we used for a single system and the same correlation matrix found in the QSLS Book of Knowledge.

$$VSoSQASA = ( VSoSCSA * MR - ACSA - AQASA )$$

One can either use the basic VSoSQASA vector or adjust based on Customer interest on Quality Attributes as identified above to create a VSoSQASA′ vector to use.

$$VSoSBD = ( VSoSQASA * MR - AQASA - BD )$$

$${VSoSBD}^{′} = ( {VSoSQASA}^{′} * MR - AQASA - BD )$$

### View of Minimum, Maximum, Average, Median computations

The results of the provided math will provide a projection of how a System (or System of System) Architecture supports both Quality Attributes as well as Business Drivers. In the early section of the math, we computed Min, Max, Average, Median for the Mechanism Part Components:
VSAPCAVG
VSAPCMedian
VSAPCMin
VSAPCMax

By applying these different vectors in the math and computing the Average, Median, Min, Max of the outputs, we can arrive at the bounds and structure of the Characteristics, Quality Attributes and Business Drivers. Because in Matrix Math, one compute averages of relationships, our final output consists of:
AQAAvgn=The Average support level of a Quality Attribute (n)
AQAMediann=The Average of the Median support level of a Quality Attribute (n)
AQAMinn=The Average of the Maximum support level of a Quality Attribute (n)
AQAMaxn=The Average of the Minimum support level of a Quality Attribute (n)

And likewise for Business Drivers:
VSBDAvg=The vector (list) of Average of the Average support levels for Business Drivers;
VSBDMedian=The vector (list) of Median of the Median support levels for Business Drivers;
VSBDMin=The vector (list) of Minimum of the Minimum support levels for Business Drivers; and
VSBDMax=The vector (list) of Maximum of the Maximum support levels for Business Drivers.

All the outputs are computed to range from 0 to 1. This can be re-interpreted as a percentage of support (or percentage of level of support) by converting to 0 to 100 (multiply by 100 to get percentage).

The nodal computations of correlation between different elements result in a spectrum of values ranging from near 0 (little to no correlation) to 1 (full correlation). As such when developing the relationship matrices, we see that the matrices have a spectrum of values.

While the low-level correlations pull (reduce the average) from the high-level correlations in the matrix math, we can “filter” these low levels out to focus results on higher level correlations. To filter out these values we change from normal matrix mathematics to sparse matrix-based mathematics.

The level where the correlations can be considered “actual” in nature is found to be around 0.4 to 1.0. Lower values are less reliable in terms of actual relationship to true correlation. It is suggested that filters be set around 0.4 therefore accepting correlation values at 0.4 to 1.0 and setting all other correlation node points to 0 (no real correlation). Accepting correlations below 0.2 can be done but is close to accepting noised in the computation. The decision is left to the Architect as to what the correlation filter is set to in the QSLS tool.

The results are that high levels of support result in driving the computations. But “filtering” has a limit and at the extreme point, distorts the results. When comparing different systems under different viewpoints, the filtering levels must be equivalent to make a proper comparison. This filtering approach can also be applied to the starting vector of Mechanism weights. This again must be approached with care as at the extremes can result in no Mechanisms being available to compute results. By applying the filters, the application may be focusing on the key relationships and taking away the less important relationships found in the math.

The QSLS Architecture Book of Knowledge. The QSLS Book of Knowledge (BoK) is provide in database and blockchain form to allow users of QSLS to examine information and perform computations related to assessing a System or System of Systems Architecture.

The Architecture QSLS BoK may contain the following:
Tables of Industry Standards and their mappings to Architectural Mechanisms;
Definitions of working elements: Architectural Mechanisms and weight for various viewpoints:
Tables of Identified Viewpoints;
Architectural Mechanism Part Components;
Architectural Characteristics;
Architectural Characteristic System Attributes;
Architectural Quality Attributes;
Architectural Quality Attribute Sub-Attributes;
Architectural Business Drivers;
Computed Tables of Linguistic Correlations:
Mechanism to Mechanism Part Components. Note that for Design and Pre-Implementation, Mechanism are directly related to Characteristic Attributes since the Mechanisms are more focused and direct with less variation than at the broader Architectural Level;
Part Components to Characteristic System Attributes;
Characteristic System Attributes to Quality Attribute Sub-Attributes;
Quality Attribute Sub-Attributes to Business Drivers;
Table of Architectural Requirement statements for Architectural Mechanisms;
Table of Architectural Requirement statements for Standards; and
AI query questions and files provided to AI to support Query to generate information sets.

The Computed Tables of Linguistic Correlations may be developed by working with the Artificial Intelligence tool such as Claude 3 Opus. AI queries are included in the Book of Knowledge for recording how AI is asked to generate outputs. Once QSLS Book of Knowledge was constructed, various designs were run using the math equations to validate the input/output expectations:
Define a set of Mechanism weights to 1, all Mechanism Part Component values to 1 and design that the output vector is a unity vector;
Using all matrices set to 1 and ensure that results are mathematically consistent including use of normalizations;
Using Standards to support System Analysis may be applied as follows.

Standards play an important position in dealing with Architecting a system. Sometimes standards are imposed by the customer, sometimes standards lay the groundwork for cost effective system development.

Standards come in many forms, some are developed by national or international committees. Other standards are developed by internal government working groups. In the area of standards for system architectures, QSLS has approached the use of standards through the Artificial Intelligence analysis of standards in terms of relationship to System Architecture Mechanisms.

QSLS uses AI to analyze standards and identify key mechanisms that tie to each analyzed standard. This base set of information is maintained in the Book of Knowledge for use by the Architect. When the Architect selects a standard for use, QSLS sets a base set of Mechanisms for the Architecture. This mechanism list can then be expanded for other features identified for the System Architecture and fed into the analysis through the system weight vector (VAMW).

The Architect can decide on which of the Standard designated System Architecture Mechanisms are to be applied by setting those that in the opinion of the Architect do not relate to a weight value of 0 (this will eliminate the Mechanism from the computations).

As in the case of linguistic correlations, the correlation of mechanisms to a standard produces a large list, which may have marginal true relationships other than secondary linguistic matching.

According to the disclosed embodiments, the ability to quantify (measure) system concepts at levels of Architecture, Design and Pre-Implementation based on Mechanisms at each level and their mapping relationships between levels, allows for the tracing of Mechanisms as the process transitions from one level to the next. This use of Mechanisms and mappings, combined with other normal processes such as Relationship modeling and requirements tracing, now forms a comprehensive process flow for the Architect.

When developing a project, the Architect now can use tools to model relationships and define requirements related to Mechanisms at each level and then combined with the QSLS mathematics, measure the Characteristics, Quality Attributes and Business Driver level of support at each level. Combined with building the QSLS measurements, the process supports tracing the basic Mechanisms from Architecture to Design to Pre-Implementation to ensure that at levels below Architecture, any excursions33 are identified, traced and managed. If excursions are found to be necessary at lower levels outside the bounds set by the upper level(s), the effects can be analyzed, and adjustments to Mechanism selections is made at higher levels to support tracing such that the lower-level excursion can be brought back into the correct flow from the Architecture definition while also observing the effect of the excursion corrections at each level on computed Characteristics, Quality Attributes and Business Drivers. The QSLS process for an architect (or architect team) is to complete the flow and insure consistency across all three levels:

Model, Identify Mechanisms and set Architectural Requirements along with measurement of the Characteristic, Quality Attributes and Business Driver level of support.

Model, Identify Mechanisms (traced to Architectural Mechanisms) and set of Architectural Requirements (traced to Architectural Requirements) at the Design level, along with measurement of the Characteristic, Quality Attributes and Business Driver level of support.

Model, Identify Mechanisms (traced to Architectural Mechanisms) and set of Architectural Requirements (traced to Architectural Requirements) at the Pre-Implementation level, along with measurement of the Characteristic, Quality Attributes and Business Driver level of support.

The combined use of Correlation functions and Matrix Math means the results are non-linear in nature. This use of linguistic correlation at levels below Characteristics and Quality Attributes allows for a higher level of correlation between more focused elements than the general units of Mechanisms, Characteristics and Quality Attributes which have broad definitions (especially at the Architectural level) and thus produces less focused areas to support linguistic correlations. The QSLS approach provides a consistent structured approach requiring the Architect to only identify Mechanisms and viewpoint to be used in structuring of the System Architecture and setting (or accepting) a strength value against each of the Mechanisms relating the Mechanism to the viewpoint to be considered.

In one embodiment, other features may be added by the QSLS tool:
The QSLS tool also supports definition and generation of System of Systems levels of support for Quality Attributes and Business Drivers. In Addition, the QSLS tool will provide related first estimate Architecture Requirements that can be tailored based on the Architecture concept.
Another feature of the QSLS tool is the ability to define multiple Architectures and compare the levels of support for Quality Attributes and Business Driver computations between the different Architectures.
Selection of viewpoints for computations.

The Characteristics, Quality Attributes and Business Drivers are relative to the selected viewpoint specified for analysis. This means that when the Quality Attribute of “Robustness” is computed, it is Robustness relative to the viewpoint specified for the analysis (Robustness for a System Structure, Security, Functional, etc.).

The present disclosure provides a system, method and computer-readable medium for AI-based real-time quantifying levels of support based on requested system architecture data. In one embodiment, the system overcomes the limitations of existing methods of automated design by employing fine-tuned models derived from pre-trained language models to extract and process the user requested architecture information, irrespective of data format, style, or data type. By leveraging the capabilities of the pre-trained language models and predictive models, the disclosed approach offers a significant improvement over existing solutions discussed above in the background section.

In one embodiment of the present disclosure, the system provides for an AI and machine learning (ML)-generated design correlation parameters for level of support of the architecture mechanisms of a given viewpoint. In one embodiment, an architecture predictive model may be generated to provide for design correlation parameters update recommendation parameters associated with the updated user system architecture request. The architecture predictive model may use historical user architecture-related data collected at the current design location (or site) and at design facilities of the same type located within a certain range from the current location or even located globally. The relevant historical architecture-related data may include data related to other projects having the same parameters such as type of technical field, area of specialization, budgets, locations, jurisdiction, etc. The relevant architecture-related data may indicate successfully designed and implemented systems based on the analytics.

In one embodiment, to enhance this process, the system may integrate advanced technologies discussed above, such as Artificial Intelligence (AI) and machine-learning (ML) and Blockchain. The AI may be leveraged for several key functions in the following manner discussed herein.

Additionally, the disclosed predictive design system may incorporate Blockchain technology to ensure the transparency and immutability of transactions, providing a secure and trustworthy platform. By embedding these advanced technologies, the disclosed system for quantifying system levels of support based on requested system architecture data, advantageously, offers a sophisticated and secure solution.

As discussed above, in one disclosed embodiment, the AI/ML technology may be combined with a blockchain technology for secure use of the user architecture-related data and architecture viewpoint-based parameters'data. In one embodiment, a blockchain consensus may need to be implemented prior to provision of the final design correlation parameters for level of support of the architecture mechanisms of a given viewpoint to the user who had provided a system architecture request.

In one embodiment, design-related documents and reports may be stored in a form of uniquely minted NFTs on the private (permissioned) blockchain ledger. In one embodiment, the ML module may use architecture predictive model(s) that use an artificial neural network (ANN) to generate design correlation parameters for level of support of the architecture mechanisms of a given viewpoint parameters. The use of specially trained ANNs provides a number of improvements over traditional methods of analyzing of architecture-related data received from the user, including more accurate prediction of what additional or updated design correlation parameters may be generated. The application further provides methods for training the ANN that leads to a more accurate predictive model(s).

In one embodiment, the ANN can be implemented by means of computer-executable instructions, hardware, or a combination of the computer-executable instructions and hardware. In one embodiment, neurons of the ANN may be represented by a register, a microprocessor configured to process input signals. Each neuron produces an output, or activation, based on an activation function that uses the outputs of the previous layer and a set of weights as inputs. Each neuron in a neuron array may be connected to another neuron via a synaptic circuit. A synaptic circuit may include a memory for storing a synaptic weight. A proposed ANN may be implemented as a Deep Neural Network having an input layer, an output layer, and several fully connected hidden layers. The proposed ANN may be particularly useful in production of design correlation parameters because the ANN can effectively extract features from the architecture-related data in linear and non-linear relationships. In some embodiments, the proposed ANN may be implemented by an application-specific integrated circuit (ASIC). The ASICs may be specially designed and configured for a specific AI application and provide superior computing capabilities and reduced electricity and computational resources consumption compared to the traditional CPUs.

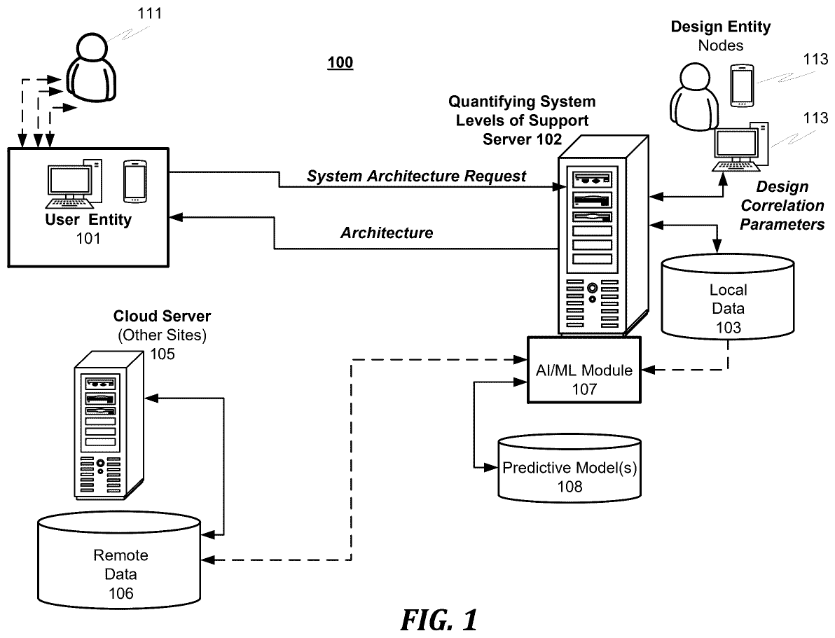

FIG. 1 illustrates a network diagram of a system for an AI-based real-time quantifying levels of support based on requested system architecture data consistent with the present disclosure.

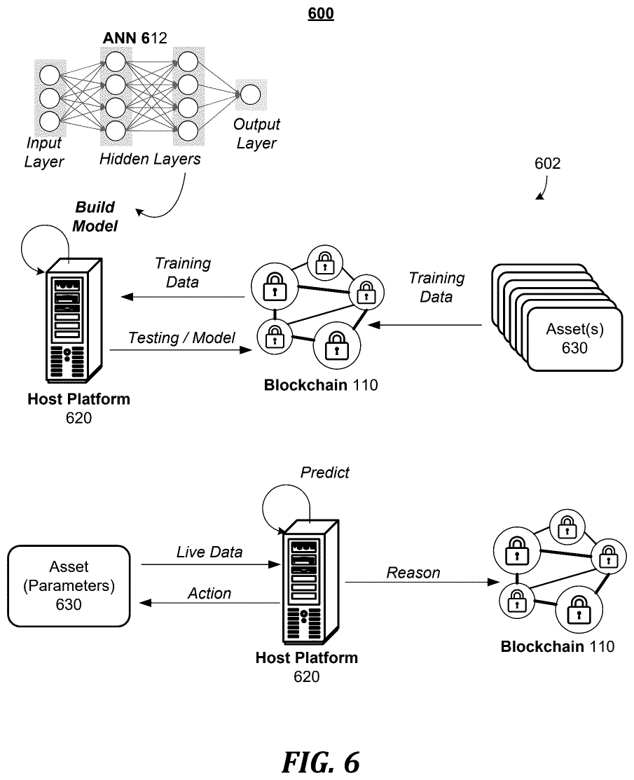

Referring to FIG. 1, the example network 100 includes the Quantifying System Levels of Support (QSLS) Server node 102 connected to a cloud server node(s) 107 over a network. The QSLS server node 102 is configured to host an AI/ML module 107 couple to the ANN (shown in FIG. 6). The QSLS server node 102 may receive system architecture request data from the user-entity node 101 associated with the user 111. The QSLS server node 102 may receive conversation data related to communication between the user entity 101 and the designer entity represented 113 by a Chatbot (not shown) supported by the AI/ML module 107 of the QSLS server node 102.

The system architecture request data may have language indicator metadata representing the language of the user 111. In one embodiment, the system architecture request data may be processed by the QSLS server node 102 using the pre-trained large language models. The QSLS node 102 may derive the language indicator and parse out the system architecture request data based on the language indicator metadata. In other words, the key features of the system architecture request data may be, advantageously, derived from the system architecture request data based on the language of the user response or email, text or other communication.

In one embodiment, the language indicator may serve as a kind of a linguistic profile associated with the user 111. The language indicator may guide the AI/ML module 107 in dynamically tailoring the design update parameters for the Chatbot. Depending on the language indicated, the QSLS server node 102 may engage specialized language models or apply unique natural language processing techniques optimized for that language.

Regarding the global reach of the disclosed system and method, a cultural intelligence layer may be added to the language indicator. The goal of this layer is for the system to not only recognize the language, but also adapt its recommendations and interactions to be culturally sensitive and appropriate for the user 111 (i.e., a system architect or an engineer/developer). In one embodiment, the disclosed system may employ integrated translation capabilities. This may allow both the user 111 and the design entity 113 associated with the QSLS server node 102 to communicate effortlessly via the Chatbot, no matter where they are in the world or what languages they use. The language indicator metadata may support and/or trigger this feature, making the system truly globally effective.

The QSLS server node 102 may query a local architecture-related database 103 for the historical local architecture-related data based on the user architecture request data associated with the current user entity 101 node. The QSLS server node 102 may acquire relevant remote architecture-related data from a remote database 106 residing on the cloud server 107. The remote architecture-related data in the database 106 may be collected from other third-party design or development facilities. The remote architecture-related data may be collected from the user entities associated with the users of the same (or similar) type, age, gender, location, language, race, type of project, budget, technology area jurisdiction, etc. as the local user 111 based on a user profile.

The QSLS server node 102 may generate a feature vector or classifier data based on the system architecture request data and the collected heuristics data (i.e., pre-stored local data 103 and remote data 106). The QSLS server node 102 may ingest the feature vector/classifier data into an AI/ML module 107. The AI/ML module 107 may generate a predictive architecture correlation model(s) 108 based on the feature vector/classifier data to predict design correlation parameters for level of support of the architecture mechanisms of a given viewpoint. The design correlation parameters may be further analyzed by the QSLS server node 102 prior to kick off and/or generation of the actual designs. In one embodiment, the design correlation parameters may be used for adjustment of the overall system or project design.

The disclosed system 100 may Generate Mechanism Part Components Level of Support. This data may be used as inputs for computing Characteristic System Types Level of Support. This data is in turn used as feeds for computing Quality Attribute Sub-Attribute Level of Support. Finally, the system computes Business Driver Level of support based on the Quality Attribute Sub-Attribute Level of Support. Note that each step is based on the identified Architectural Mechanisms Level of Support for a given Viewpoint. Note that QSLS applies the same algorithm across Architecture, Design and Implementation to provide quantitative measurements of Characteristics, Quality Attributes and Business Drivers at each level (note that the Characteristics and Quality Attributes are different at each of the levels).

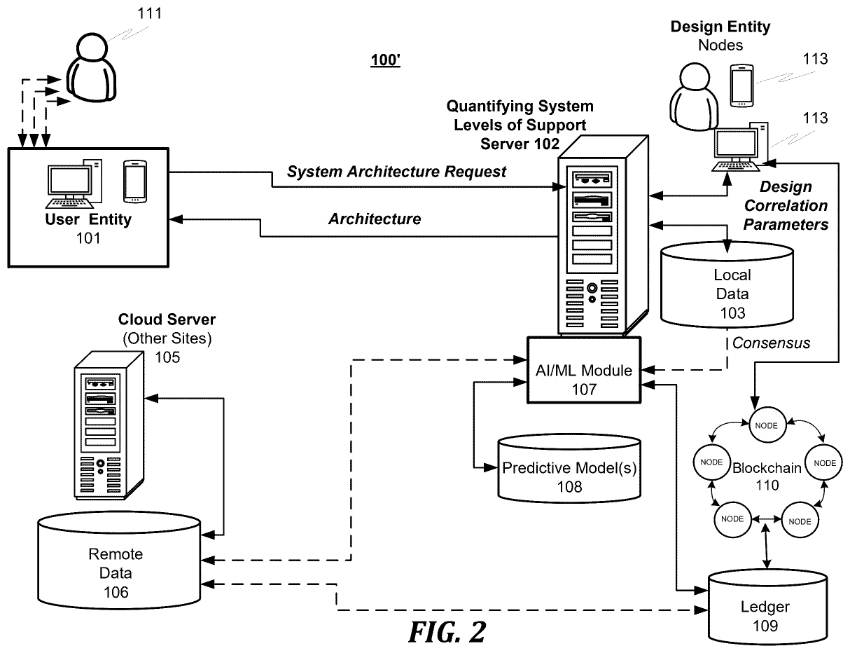

FIG. 2 illustrates a network diagram of a system for an AI-based real-time quantifying levels of support based on requested system architecture data implemented over a blockchain network consistent with the present disclosure.

Referring to FIG. 2, the example network 100′ includes the Quantifying System Levels of Support (QSLS) Server node 102 connected to a cloud server node(s) 107 over a network. The QSLS server node 102 is configured to host an AI/ML module 107 couple to the ANN (shown in FIG. 6). The QSLS server node 102 may receive system architecture request data from the user-entity node 101 associated with the user 111. The QSLS server node 102 may receive conversation data related to communication between the user entity 101 and the designer entity represented 113 by a Chatbot (not shown) supported by the AI/ML module 107 of the QSLS server node 102.

The system architecture request data may have language indicator metadata representing the language of the user 111. In one embodiment, the system architecture request data may be processed by the QSLS server node 102 using the pre-trained large language models. The QSLS node 102 may derive the language indicator and parse out the system architecture request data based on the language indicator metadata.

The QSLS server node 102 may query a local architecture-related database 103 for the historical local architecture-related data based on the user architecture request data associated with the current user entity 101 node. The QSLS server node 102 may acquire relevant remote architecture-related data from a remote database 106 residing on the cloud server 107. The remote architecture-related data in the database 106 may be collected from other third-party design or development facilities. The remote architecture-related data may be collected from the user entities associated with the users of the same (or similar) type, age, gender, location, language, race, type of project, budget, technology area jurisdiction, etc. as the local user 111 based on a user profile.

The QSLS server node 102 may generate a feature vector or classifier data based on the system architecture request data and the collected heuristics data (i.e., pre-stored local data 103 and remote data 106). The QSLS server node 102 may ingest the feature vector/classifier data into an AI/ML module 107. The AI/ML module 107 may generate a predictive architecture correlation model(s) 108 based on the feature vector/classifier data to predict design correlation parameters for level of support of the architecture mechanisms of a given viewpoint. The design correlation parameters may be further analyzed by the QSLS server node 102 prior to kick off and/or generation of the actual designs. In one embodiment, the design correlation parameters may be used for adjustment of the overall system or project design.

In one embodiment, the QSLS server node 102 may receive the design correlation parameters for level of support of the architecture mechanisms of a given viewpoint from a permissioned blockchain 110 ledger 109 based on a consensus from the design entity nodes 113 confirming the design for the user entity 101. Additionally, confidential historical user-related information and previous users-related data and architecture-related parameters may also be acquired from the permissioned blockchain 110. The newly acquired system architecture request data with corresponding predicted design correlation parameters data may be also recorded on the ledger 109 of the blockchain 110 so it can be used as training data for the predictive model(s) 108.

In this implementation the QSLS node 102, the cloud server 107, the design entity nodes 113 and the user entities(s) 101 may serve as blockchain 110 peer nodes. In one embodiment, local data from the database 103 and remote data from the database 106 may be duplicated on the blockchain ledger 109 for higher security of storage.

The AI/ML module 107 may generate a predictive architecture correlation model(s) 108 to predict the design correlation parameters for level of support of the architecture mechanisms of a given viewpoint in response to the specific relevant pre-stored design-related data acquired from the blockchain 110 ledger 109. This way, the current design correlation parameters may be predicted based not only on the current user entity 101-related data, but also based on the previously collected heuristics. This way, the most optimal way of generation of the design for the user 111 may be recorded. After the design data processing and a feedback report generation is completed, the related documents may be converted into unique secure NFT assets to be recorded on the blockchain to be used for future architecture correlation model training.

In one embodiment, as a second round of approval, a blockchain consensus may be achieved among the design entities 113 in order to approve the design feedback report generated by the QSLS node 102.

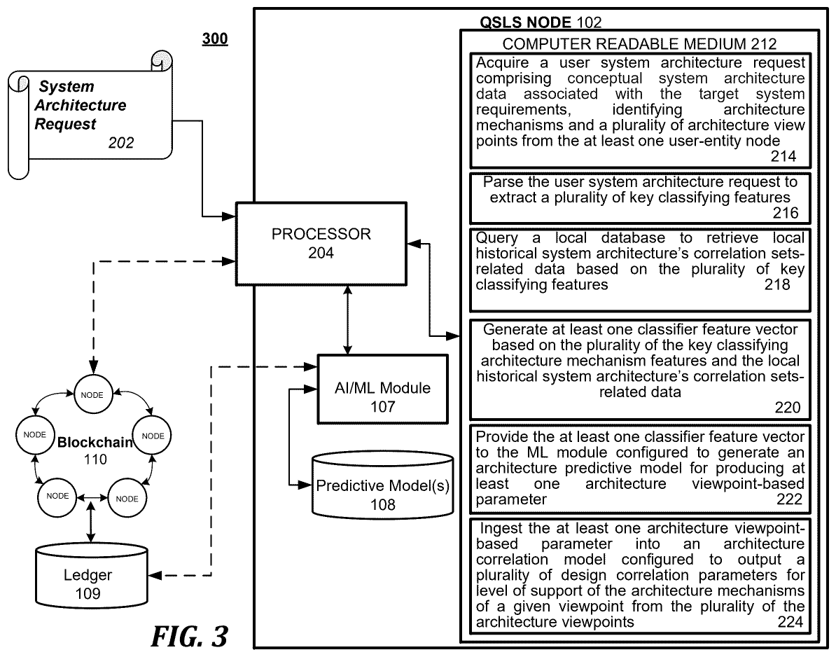

FIG. 3 illustrates a network diagram of a system including detailed features of a Quantifying System Levels of Support (QSLS) Server node consistent with the present disclosure.

Referring to FIG. 3, the example network 300 includes the QSLS server node 102 connected to the user entity 101 and to the design entity node(s) 113 (see FIGS. 1-2) to receive the system architecture request data 202. As discussed above, the QSLS node 102 may be connected to the Chatbot to receive the conversation data between the user 111 and designer entities 113 as discussed above with reference to FIGS. 1-2.

The QSLS server node 102 is configured to host an AI/ML module 107. As discussed above with respect to FIGS. 1-2, the QSLS node 102 may receive the system architecture request data 202 and pre-stored architecture-related data retrieved from the local and remote databases. As discussed above, the pre-stored architecture-related data may be retrieved from the ledger 109 of the permissioned blockchain 110.

The AI/ML module 107 may generate the architecture correlation predictive model(s) 108 based on the received system architecture request data 202 provided by the QSLS server node 102. As discussed above, the AI/ML module 107 may provide predictive outputs data in the form of design correlation parameters for level of support of the architecture mechanisms of a given viewpoint for automatic generation of updated design parameters. The QSLS server node 102 may process the predictive outputs data received from the AI/ML module 107 to generate the design recommendations.

In one embodiment, the QSLS node 102 may continually monitor the system architecture request data and conversation data and may detect a parameter that deviates from a previous recorded parameter (or from a median reading value) by a margin that exceeds a threshold value pre-set for this particular parameter. For example, if user's 111 architecture request changes significantly, this may cause a change in design recommendations provided to the design entities 113. Accordingly, once the threshold is met or exceeded by at least one parameter of the user entity-related data, the QSLS server node 102 may provide the currently acquired user related parameter to the AI/ML module 107 to generate an updated design correlation parameter(s) based on the current user 111-related data.

While this example describes in detail only one QSLS server node 102, multiple such nodes may be connected to the network and to the blockchain 110. It should be understood that the QSLS server node 102 may include additional components and that some of the components described herein may be removed and/or modified without departing from a scope of the QSLS server node 102 disclosed herein. The QSLS server node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the QSLS server node 102 may include multiple processors, multiple cores, or the like, without departing from the scope of the QSLS server node 102 system.

The QSLS server node 102 may also include a non-transitory computer readable medium 212 that may have stored thereon machine-readable instructions executable by the processor 204. Examples of the machine-readable instructions are shown as 214-224 and are further discussed below. Examples of the non-transitory computer readable medium 212 may include an electronic, magnetic, optical, or other physical storage device that contains or stores executable instructions. For example, the non transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire a user system architecture request comprising conceptual system architecture data associated with the target system requirements, identifying architecture mechanisms and a plurality of architecture view points from the at least one user-entity node 101 (FIGS. 1-2). The processor 204 may fetch, decode, and execute the machine-readable instructions 216 to parse the user system architecture request to extract a plurality of key classifying features. The processor 204 may fetch, decode, and execute the machine-readable instructions 218 to query a local database to retrieve local historical system architecture's correlation sets-related data based on the plurality of key classifying features. The processor 204 may fetch, decode, and execute the machine-readable instructions 220 to generate at least one classifier feature vector based on the plurality of the key classifying architecture mechanism features and the local historical system architecture's correlation sets-related data.

The processor 204 may fetch, decode, and execute the machine-readable instructions 222 to provide the at least one classifier feature vector to the ML module configured to generate an architecture predictive model for producing at least one architecture viewpoint-based parameter. The processor 204 may fetch, decode, and execute the machine-readable instructions 224 to ingest the at least one architecture viewpoint-based parameter into an architecture correlation model configured to output a plurality of design correlation parameters for level of support of the architecture mechanisms of a given viewpoint from the plurality of the architecture viewpoints.

As a non-limiting example, the consensual approval of the design report may be associated with a request for additional data such as proof of the design completion, etc. The permissioned blockchain 110 may be configured to use one or more smart contracts that manage transactions for multiple participating nodes and for recording the transactions on the ledger 109.

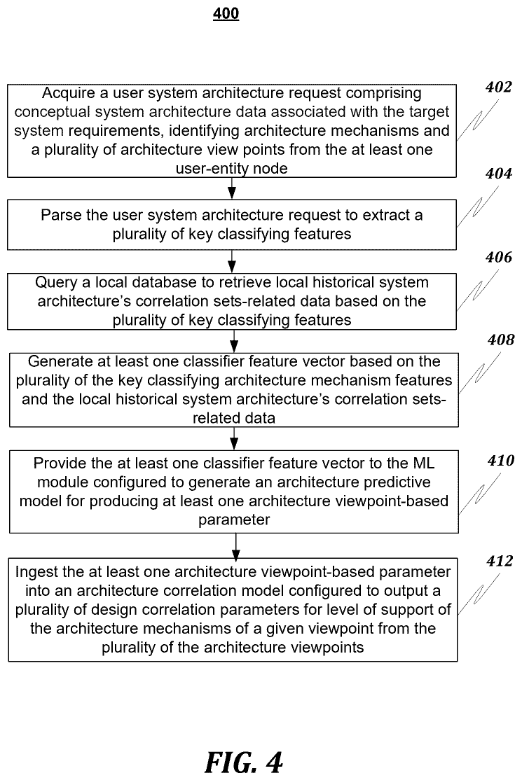

FIG. 4 illustrates a flowchart of a method for an AI-based real-time quantifying levels of support based on requested system architecture data consistent with the present disclosure.

Referring to FIG. 4, the method 400 may include one or more of the steps described below. FIG. 4 illustrates a flow chart of an example method executed by the QSLS server node 102 (see FIG. 3). It should be understood that method 400 depicted in FIG. 4 may include additional operations and that some of the operations described therein may be removed and/or modified without departing from the scope of the method 400. The description of the method 300 is also made with reference to the features depicted in FIG. 3 for purposes of illustration. Particularly, the processor 204 of the QSLS server node 102 may execute some or all of the operations included in the method 400.

With reference to FIG. 4, at block 402, the processor 204 may acquire a user system architecture request comprising conceptual system architecture data associated with the target system requirements, identifying architecture mechanisms and a plurality of architecture view points from the at least one user-entity node.

At block 404, the processor 204 may parse the user system architecture request to extract a plurality of key classifying features. Note that the system architecture request data may be any of: audio data, video data, imaging data and textual data. At block 406, the processor 204 may query a local database to retrieve local historical system architecture's correlation sets-related data based on the plurality of key classifying features. At block 408, the processor 204 may generate at least one classifier feature vector based on the plurality of the key classifying architecture mechanism features and the local historical system architecture's correlation sets-related data. At block 410, the processor 204 may provide the at least one classifier feature vector to the ML module configured to generate an architecture predictive model for producing at least one architecture viewpoint-based parameter.

At block 412, the processor 204 may ingest the at least one architecture viewpoint-based parameter into an architecture correlation model configured to output a plurality of design correlation parameters for level of support of the architecture mechanisms of a given viewpoint from the plurality of the architecture viewpoints.

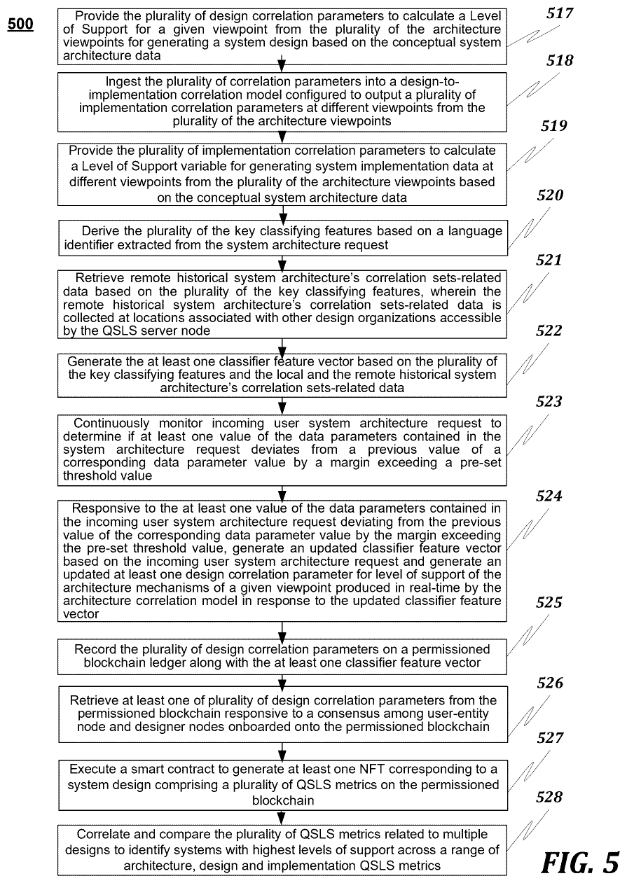

FIG. 5 illustrates a further flowchart of a method for an AI-based real-time quantifying levels of support based on requested system architecture data consistent with the present disclosure.

Referring to FIG. 5, the method 500 may include one or more of the steps described below. FIG. 5 illustrates a flow chart of an example method executed by the QSLS server node 102 (see FIG. 3). It should be understood that method 500 depicted in FIG. 5 may include additional operations and that some of the operations described therein may be removed and/or modified without departing from the scope of the method 500. The description of the method 500 is also made with reference to the features depicted in FIG. 3 for purposes of illustration. Particularly, the processor 204 of the QSLS server 102 may execute some or all of the operations included in the method 500.

With reference to FIG. 5, at block 517, the processor 204 may provide the plurality of design correlation parameters to calculate a Level of Support for a given viewpoint from the plurality of the architecture viewpoints for generating a system design based on the conceptual system architecture data.

At block 518, the processor 204 may ingest the plurality of correlation parameters into a design-to-implementation correlation model configured to output a plurality of implementation correlation parameters at different viewpoints from the plurality of the architecture viewpoints. At block 519, the processor 204 may provide the plurality of implementation correlation parameters to calculate a Level of Support variable for generating system implementation data at different viewpoints from the plurality of the architecture viewpoints based on the conceptual system architecture data. At block 520, the processor 204 may derive the plurality of the key classifying features based on a language identifier extracted from the system architecture request. At block 521, the processor 204 may retrieve remote historical system architecture's correlation sets-related data based on the plurality of the key classifying features, wherein the remote historical system architecture's correlation sets-related data is collected at locations associated with other design organizations accessible by the QSLS server node.

At block 522, the processor 204 may generate the at least one classifier feature vector based on the plurality of the key classifying features and the local and the remote historical system architecture's correlation sets-related data. At block 523, the processor 204 may continuously monitor incoming user system architecture request to determine if at least one value of the data parameters contained in the system architecture request deviates from a previous value of a corresponding data parameter value by a margin exceeding a pre-set threshold value.

At block 524, the processor 204 may responsive to the at least one value of the data parameters contained in the incoming user system architecture request deviating from the previous value of the corresponding data parameter value by the margin exceeding the pre-set threshold value, generate an updated classifier feature vector based on the incoming user system architecture request and generate an updated at least one design correlation parameter for level of support of the architecture mechanisms of a given viewpoint produced in real-time by the architecture correlation model in response to the updated classifier feature vector. At block 527, the processor 204 may record the plurality of design correlation parameters on a permissioned blockchain ledger along with the at least one classifier feature vector. At block 526, the processor 204 may retrieve at least one of plurality of design correlation parameters from the permissioned blockchain responsive to a consensus among user-entity node and designer nodes onboarded onto the permissioned blockchain. At block 527, the processor 204 may execute a smart contract to generate at least one NFT corresponding to a system design comprising a plurality of QSLS metrics on the permissioned blockchain.

At block 528, the processor 204 may correlate and compare the plurality of QSLS metrics related to multiple designs to identify systems with highest levels of support across a range of architecture, design and implementation QSLS metrics.

In one disclosed embodiment, the design predictive model may be generated by the AI/ML module 107 that may use training data sets to improve accuracy of the prediction of the design correlation parameters for level of support of the architecture mechanisms of a given viewpoint. The design correlation parameters used in training data sets may be stored in a centralized local database (such as one used for storing local designs data 103 depicted in FIG. 1). In one embodiment, a neural network may be used in the AI/ML module 107 for the design correlation parameters modeling and feedback report generation.

In another embodiment, the AI/ML module 107 may use a decentralized storage such as a blockchain 110 (see FIG. 2) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 101, 113, 107 and 102 (FIG. 2) may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as storing recommendation parameters, but which do not fully trust one another.

This application utilizes a permissioned (private) blockchain that operates arbitrary, programmable logic, tailored to a decentralized storage scheme and referred to as “smart contracts” or “chaincodes.”

The permissioned blockchain is a type of blockchain network where participation is restricted to authorized entities. In the context of QSLS, it is used to securely store and validate architecture and design-related data, ensuring traceability and immutability of decision records. Smart contracts reflect self-executing code deployed on the permissioned blockchain that automatically enforces rules, manages transactions, and updates state based on predefined conditions. In the QSLS, smart contracts may be used to automate the recording of design decisions, update of QSLS metrics, or generation of NFTs (Non-Fungible Tokens) that are unique digital asset on the blockchain representing ownership or proof of authenticity of a specific item. In the QSLS context, an NFT represents a unique system design parameters or set of QSLS metrics, providing a tamper-proof record of the design and its associated quantitative assessments.

In some cases, specialized chaincodes may exist on blockchain for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

In the example 600 depicted in FIG. 6, a host platform 620 (such as the QSLS server node 102) builds and deploys a machine learning model for predictive monitoring of assets 630. Here, the host platform 620 may be a cloud platform, an industrial server, a web server, a personal computer, a user device, and the like. Assets 630 can represent design correlation parameters. The blockchain 110 can be used to significantly improve both a training process 602 of the machine learning model and the design correlation parameters predictive process 607 based on a trained machine learning model that uses outputs of the ANN 612. For example, in 602, rather than requiring a data scientist/engineer or other user to collect the data, historical data (heuristics—i.e., architecture-related data) may be stored by the assets 630 themselves (or through an intermediary, not shown) on the blockchain 110.

This can significantly reduce the collection time needed by the host platform 620 when performing predictive model training. For example, using smart contracts, data can be directly and reliably transferred straight from its place of origin (e.g., from the QSLS server node 102 or from the databases 103 and 106 depicted in FIGS. 1-2) to the blockchain 110. By using the blockchain 110 to ensure the security and ownership of the collected data, smart contracts may directly send the data from the assets to the entities that use the data for building a machine learning model. This allows for sharing of data among the assets 630. The collected data may be stored in the blockchain 110 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and designing by the host platform 620. Each round may be based on additional data or data that was not previously considered to help expand the knowledge of the machine learning model. In 602, the different training and designing steps (and the data associated therewith) may be stored on the blockchain 110 by the host platform 620. Each refinement of the machine learning model (e.g., changes in variables, weights, etc.) may be stored on the blockchain 110. This, advantageously, provides verifiable proof of how the model was trained and what data was used to train the model. Furthermore, when the host platform 620 has achieved a finally trained model, the resulting model itself may be stored on the blockchain 110.

After the model has been trained, it may be deployed to a live environment where it can make recommendation-related predictions/decisions based on the execution of the final trained machine learning model using the prediction parameters. In this example, data fed back from the asset 630 may be input into the machine learning model and may be used to make predictions such as design correlation parameters based on the recorded user designs and architecture-related data. Determinations made by the execution of the machine learning model (e.g., approval of design feedback reports, etc.) at the host platform 620 may be stored on the blockchain 110 to provide auditable/verifiable proof. As one non-limiting example, the machine learning model may predict a future change of a part of the asset 630 (the design correlation parameters - i.e., assessment of the target system architecture). The data behind this decision may be stored by the host platform 620 on the blockchain 110.

As discussed above, in one embodiment, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

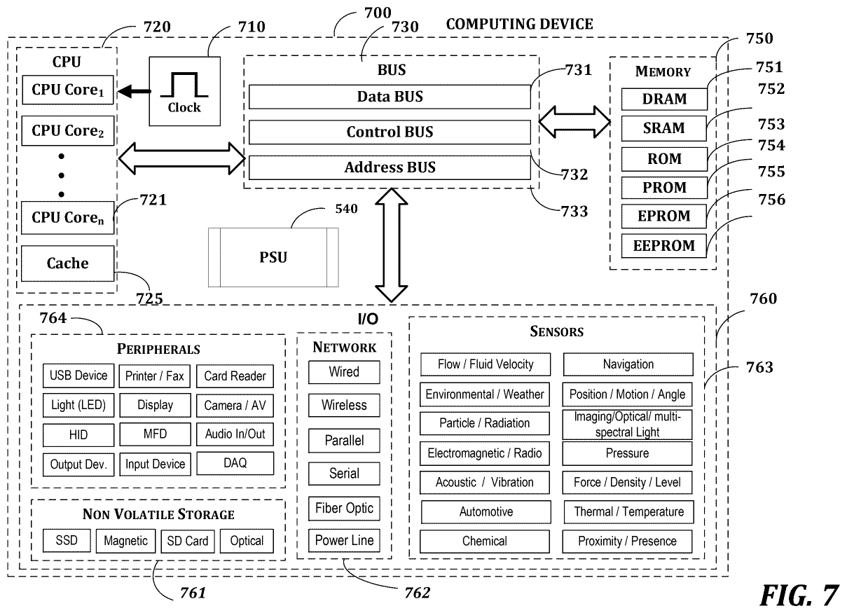

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 7 illustrates an example computing device (e.g., a server node) 700, which may represent or be integrated in any of the above-described components, etc.

FIG. 7 illustrates a block diagram of a system including computing device 700. The computing device 700 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS700/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
The QSLS server node 102 (see FIG. 3) may be hosted on a centralized server or on a cloud computing service. Although method 400 has been described to be performed by the QSLS server node 102 implemented on a computing device 700, it should be understood that, in some embodiments, different operations may be performed by a plurality of the computing devices 700 in operative communication at least one network.

Embodiments of the present disclosure may comprise a computing device having a central processing unit (CPU) 720, a bus 730, a memory unit 770, a power supply unit (PSU) 770, and one or more Input/Output (I/O) units. The CPU 720 coupled to the memory unit 770 and the plurality of I/O units 760 via the bus 730, all of which are powered by the PSU 770. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 720, the bus 730, the memory unit 770, a PSU 770, and the plurality of I/O units 760 may be implemented in a computing device, such as computing device 700. Any suitable combination of hardware, software, or firmware may be used to implement the aforementioned units. For example, the CPU 720, the bus 730, and the memory unit 770 may be implemented with computing device 700 or any of other computing devices 700, in combination with computing device 700. The aforementioned system, device, and components are examples and other systems, devices, and components may comprise the aforementioned CPU 720, the bus 730, the memory unit 770, consistent with embodiments of the disclosure.

At least one computing device 700 may be embodied as any of the computing elements illustrated in all of the attached figures, including the QSLS node 102 (FIG. 2). A computing device 700 does not need to be electronic, nor even have a CPU 720, nor bus 730, nor memory unit 770. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In a basic configuration, computing device 700 may include at least one clock module 710, at least one CPU 720, at least one bus 730, and at least one memory unit 770, at least one PSU 770, and at least one I/O 760 module, wherein I/O module may be comprised of, but not limited to a non-volatile storage sub-module 761, a communication sub-module 762, a sensors sub-module 763, and a peripherals sub-module 767.

A system consistent with an embodiment of the disclosure the computing device 700 may include the clock module 710 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 720, the central component of modern computers, which relies on a clock. The only exceptions are asynchronous circuits such as asynchronous CPUs. The clock 710 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 7 wires.

Many computing devices 700 use a “clock multiplier” which multiplies a lower frequency external clock to the appropriate clock rate of the CPU 720. This allows the CPU 720 to operate at a much higher frequency than the rest of the computer, which affords performance gains in situations where the CPU 720 does not need to wait on an external factor (like memory 770 or input/output 760). Some embodiments of the clock 710 may include dynamic frequency change, where the time between clock edges can vary widely from one edge to the next and back again.

A system consistent with an embodiment of the disclosure the computing device 700 may include the CPU unit 720 comprising at least one CPU Core 721. A plurality of CPU cores 721 may comprise identical CPU cores 721, such as, but not limited to, homogeneous multi-core systems. It is also possible for the plurality of CPU cores 721 to comprise different CPU cores 721, such as, but not limited to, heterogeneous multi-core systems, big. LITTLE systems and some AMD accelerated processing units (APU). The CPU unit 720 reads and executes program instructions which may be used across many application domains, for example, but not limited to, general purpose computing, embedded computing, network computing, digital signal processing (DSP), and graphics processing (GPU). The CPU unit 720 may run multiple instructions on separate CPU cores 721 at the same time. The CPU unit 720 may be integrated into at least one of a single integrated circuit die and multiple dies in a single chip package. The single integrated circuit die and multiple dies in a single chip package may contain a plurality of other aspects of the computing device 700, for example, but not limited to, the clock 710, the CPU 720, the bus 730, the memory 770, and I/O 760.

The CPU unit 720 may contain cache 722 such as, but not limited to, a level 1 cache, level 2 cache, level 3 cache or combination thereof. The aforementioned cache 722 may or may not be shared amongst a plurality of CPU cores 721. The cache 722 sharing comprises at least one of message passing and inter-core communication methods may be used for the at least one CPU Core 721 to communicate with the cache 722. The inter-core communication methods may comprise, but not limited to, bus, ring, two-dimensional mesh, and crossbar. The aforementioned CPU unit 720 may employ symmetric multiprocessing (SMP) design.

The plurality of the aforementioned CPU cores 721 may comprise soft microprocessor cores on a single field programmable gate array (FPGA), such as semiconductor intellectual property cores (IP Core). The plurality of CPU cores 721 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the aforementioned computing device 700, and/or the plurality of computing devices 700. The aforementioned communication system will be known to a person having ordinary skill in the art as a bus 730. The bus 730 may embody internal and/or external plurality of hardware and software components, for example, but not limited to a wire, optical fiber, communication protocols, and any physical arrangement that provides the same logical function as a parallel electrical bus. The bus 730 may comprise at least one of, but not limited to a parallel bus, wherein the parallel bus carry data words in parallel on multiple wires, and a serial bus, wherein the serial bus carry data in bit-serial form. The bus 730 may embody a plurality of topologies, for example, but not limited to, a multidrop/electrical parallel topology, a daisy chain topology, and a connected by switched hubs, such as USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu}Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/107 bus (e.g., PC/107-Plus, PCI/107-Express, PCI/107, and PCI-107), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1397 Interface/Firewire, Thunderbolt, and eXtensible Host Controller Interface (xHCI).

Consistent with the embodiments of the present disclosure, the aforementioned computing device 700 may employ hardware integrated circuits that store information for immediate use in the computing device 700, known to the person having ordinary skill in the art as primary storage or memory 770. The memory 770 operates at high speed, distinguishing it from the non-volatile storage sub-module 761, which may be referred to as secondary or tertiary storage, which provides slow-to-access information but offers higher capacities at lower cost. The contents contained in memory 770, may be transferred to secondary storage via techniques such as, but not limited to, virtual memory and swap. The memory 770 may be associated with addressable semiconductor memory, such as integrated circuits consisting of silicon-based transistors, used for example as primary storage but also other purposes in the computing device 700. The memory 770 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 771, Static Random-Access Memory (SRAM) 772, CPU Cache memory 727, Advanced Random-Access Memory (A-RAM), and other types of primary storage such as Random-Access Memory (RAM).
Non-volatile memory which can retain stored information even after power is removed, for example, but not limited to, Read-Only Memory (ROM) 773, Programmable ROM (PROM) 777, Erasable PROM (EPROM) 777, Electrically Erasable PROM (EEPROM) 776 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 700 may employ the communication system between an information processing system, such as the computing device 700, and the outside world, for example, but not limited to, human, environment, and another computing device 700. The aforementioned communication system will be known to a person having ordinary skill in the art as I/O 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces a plurality of hardware, such as, but not limited to, non-volatile storage 761, communication devices 762, sensors 763, and peripherals 767. The plurality of hardware is used by at least one of, but not limited to, human, environment, and another computing device 700 to communicate with the present computing device 700. The I/O module 760 may comprise a plurality of forms, for example, but not limited to channel I/O, port mapped I/O, asynchronous I/O, and Direct Memory Access (DMA).
Consistent with the embodiments of the present disclosure, the aforementioned computing device 700 may employ the non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using an intermediate area in the memory 770. The non-volatile storage sub-module 761 does not lose data when power is removed and may be two orders of magnitude less costly than storage used in memory modules, at the expense of speed and latency. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage Consistent with the embodiments of the present disclosure, the aforementioned computing device 700 may employ the communication sub-module 762 as a subset of the I/O 760, which may be referred to by a person having ordinary skill in the art as at least one of, but not limited to, computer network, data network, and network. The network allows computing devices 700 to exchange data using connections, which may be known to a person having ordinary skill in the art as data links, between network nodes. The nodes comprise network computer devices 700 that originate, route, and terminate data. The nodes are identified by network addresses and can include a plurality of hosts consistent with the embodiments of a computing device 700. The aforementioned embodiments include, but not limited to personal computers, phones, servers, drones, and networking devices such as, but not limited to, hubs, switches, routers, modems, and firewalls.

Two nodes can be networked together, when one computing device 700 is able to exchange information with the other computing device 700, whether or not they have a direct connection with each other. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 7 [IPv7], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 762 may comprise a plurality of size, topology, traffic control mechanism and organizational intent. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G,7G (such as WiMax and LTE), and 7G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 700 may employ the sensors sub-module 763 as a subset of the I/O 760. The sensors sub-module 763 comprises at least one of the devices, modules, and subsystems whose purpose is to detect events or changes in its environment and send the information to the computing device 700. Sensors are sensitive to the measured property, are not sensitive to any property not measured, but may be encountered in its application, and do not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.

Acoustic, sound and vibration sensors, such as, but not limited to, microphone, lace sensor (guitar pickup), seismometer, sound locator, geophone, and hydrophone.

Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.

Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.

Flow and fluid velocity sensors, such as, but not limited to, air flow meter, anemometer, flow sensor, gas meter, mass flow sensor, and water meter.

Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.

Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.

Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.

Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photo-switch, phototube, scintillometer, Shack-Hartmann, single-photon avalanche diode, superconducting nanowire single-photon detector, transition edge sensor, visible light photon counter, and wavefront sensor.

Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.

Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.

Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.

Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ the peripherals sub-module 762 as a subset of the I/O 760. The peripheral sub-module 767 comprises ancillary devices used to put information into and get information out of the computing device 700. There are 3 categories of devices comprising the peripheral sub-module 767, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 700. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 767:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).

High degree of freedom devices, that require up to six degrees of freedom such as, but not limited to, camera gimbals, Cave Automatic Virtual Environment (CAVE), and virtual reality systems.

Video Input devices are used to digitize images or video from the outside world into the computing device 700. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.

Audio input devices are used to capture sound. In some cases, an audio output device can be used as an input device, in order to capture produced sound. Audio input devices allow a user to send audio signals to the computing device 700 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.

Data Acquisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.

Audio and Video (AV) devices, such as, but not limited to, speakers, headphones, amplifiers and lights, which include lamps, strobes, DJ lighting, stage lighting, architectural lighting, special effect lighting, and lasers.

### Other Devices Such as Digital to Analog Converter (DAC)

Input/Output Devices may further comprise, but not be limited to, touchscreens, networking device (e.g., devices disclosed in network 762 sub-module), data storage device (non-volatile storage 761), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system for an automated Quantifying System Levels of Support (QSLS) processing based on target system requirements data, comprising:
a processor of a QSLS server node configured to host a machine learning (ML) module coupled to at least one user-entity node and a plurality of designer nodes over a network; and
a memory on which are stored machine-readable instructions that when executed by the processor, cause the processor to:
acquire a user system architecture request comprising conceptual system architecture data associated with the target system requirements comprising architecture mechanisms and a plurality of architecture view points from the at least one user-entity node;
parse the user system architecture request to extract a plurality of key classifying features;
query a local database to retrieve local historical system architecture's correlation sets-related data based on the plurality of key classifying features;
generate at least one classifier feature vector based on the plurality of the key classifying architecture mechanism features and the local historical system architecture's correlation sets-related data;
provide the at least one classifier feature vector to the ML module configured to generate an architecture predictive model for producing at least one architecture viewpoint-based parameter; and
ingest the at least one architecture viewpoint-based parameter into an architecture correlation model configured to output a plurality of design correlation parameters for level of support of the architecture mechanisms of a given viewpoint from the plurality of the architecture viewpoints.

2. The system of claim 1, wherein the machine-readable instructions that when executed by the processor, cause the processor to provide the plurality of design correlation parameters to calculate a Level of Support for a given viewpoint from the plurality of the architecture viewpoints for generating a system design based on the conceptual system architecture data.

3. The system of claim 1, wherein the plurality of key classifying features comprising Quantified values for a viewpoint's Level of Support:
Architecture Mechanism Part Components;
Architecture Characteristic System Types;
Architecture Characteristics;
Architecture Quality Attribute Sub-Attributes;
Architecture Quality Attributes; and
Business Drivers data.

4. The system of claim 2, wherein the machine-readable instructions that when executed by the processor, cause the processor to ingest the plurality of correlation parameters into a design-to-implementation correlation model configured to output a plurality of implementation correlation parameters at different viewpoints from the plurality of the architecture viewpoints.

5. The system of claim 4, wherein the machine-readable instructions that when executed by the processor, cause the processor to provide the plurality of implementation correlation parameters to calculate a Level of Support variable for generating system implementation data at different viewpoints from the plurality of the architecture viewpoints based on the conceptual system architecture data.

6. The system of claim 1, wherein the machine-readable instructions that when executed by the processor, cause the processor to derive the plurality of the key classifying features based on a language identifier extracted from the system architecture request.

7. The system of claim 1, wherein the machine-readable instructions that when executed by the processor, cause the processor to retrieve remote historical system architecture's correlation sets-related data based on the plurality of the key classifying features, wherein the remote historical system architecture's correlation sets-related data is collected at locations associated with other design organizations accessible by the QSLS server node.

8. The system of claim 7, wherein the machine-readable instructions that when executed by the processor, cause the processor to generate the at least one classifier feature vector based on the plurality of the key classifying features and the local and the remote historical system architecture's correlation sets-related data.

9. The system of claim 1, wherein the machine-readable instructions that when executed by the processor, cause the processor to continuously monitor incoming user system architecture request to determine if at least one value of the data parameters contained in the system architecture request deviates from a previous value of a corresponding data parameter value by a margin exceeding a pre-set threshold value.

10. The system of claim 9, wherein the machine-readable instructions that when executed by the processor, cause the processor to, responsive to the at least one value of the data parameters contained in the incoming user system architecture request deviating from the previous value of the corresponding data parameter value by the margin exceeding the pre-set threshold value, generate an updated classifier feature vector based on the incoming user system architecture request and generate an updated at least one design correlation parameter for level of support of the architecture mechanisms of a given viewpoint produced in real-time by the architecture correlation model in response to the updated classifier feature vector.

11. The system of claim 1, wherein the machine-readable instructions that when executed by the processor, further cause the processor to record the plurality of design correlation parameters on a permissioned blockchain ledger along with the at least one classifier feature vector.

12. The system of claim 11, wherein the machine-readable instructions that when executed by the processor, further cause the processor to retrieve at least one of plurality of design correlation parameters from the permissioned blockchain responsive to a consensus among user-entity node and designer nodes onboarded onto the permissioned blockchain.

13. The system of claim 11, wherein the machine-readable instructions that when executed by the processor, further cause the processor to execute a smart contract to generate at least one NFT corresponding to a system design comprising a plurality of QSLS metrics on the permissioned blockchain.

14. The system of claim 13, wherein the machine-readable instructions that when executed by the processor, further cause the processor to correlate and compare the plurality of QSLS metrics related to multiple designs to identify systems with highest levels of support across a range of architecture, design and implementation QSLS metrics.

15. A method for an automated Quantifying System Levels of Support (QSLS) processing based on target system requirements data, comprising:
acquiring, by a Quantifying System Levels of Support (QSLS) server node configured to host a machine learning (ML) module, a user system architecture request comprising conceptual system architecture data associated with the target system requirements comprising architecture mechanisms and a plurality of architecture view points from the at least one user-entity node;
parsing, by the QSLS server node, the user system architecture request to extract a plurality of key classifying features;
querying, by the QSLS server node, a local database to retrieve local historical system architecture's correlation sets-related data based on the plurality of key classifying features;
generating, by the QSLS server node, at least one classifier feature vector based on the plurality of the key classifying architecture mechanism features and the local historical system architecture's correlation sets-related data;
providing, by the QSLS server node, the at least one classifier feature vector to the ML module configured to generate an architecture predictive model for producing at least one architecture viewpoint-based parameter; and
ingesting, by the QSLS server node, the at least one architecture viewpoint-based parameter into an architecture correlation model configured to output a plurality of design correlation parameters for level of support of the architecture mechanisms of a given viewpoint from the plurality of the architecture viewpoints.

16. The method of claim 15, further comprising providing the plurality of design correlation parameters to calculate a Level of Support for a given viewpoint from the plurality of the architecture viewpoints for generating a system design based on the conceptual system architecture data.

17. The method of claim 15, further comprising ingesting the plurality of correlation parameters into a design-to-implementation correlation model configured to output a plurality of implementation correlation parameters at different viewpoints from the plurality of the architecture viewpoints.

18. The method of claim 17, further comprising providing the plurality of implementation correlation parameters to calculate a Level of Support variable for generating system implementation data at different viewpoints from the plurality of the architecture viewpoints based on the conceptual system architecture data.

19. The method of claim 18, further comprising:
continuously monitoring incoming user system architecture request to determine if at least one value of the data parameters contained in the system architecture request deviates from a previous value of a corresponding data parameter value by a margin exceeding a pre-set threshold value; and
responsive to the at least one value of the data parameters contained in the incoming user system architecture request deviating from the previous value of the corresponding data parameter value by the margin exceeding the pre-set threshold value, generating an updated classifier feature vector based on the incoming user system architecture request and generating an updated at least one design correlation parameter for level of support of the architecture mechanisms of a given viewpoint produced in real-time by the architecture correlation model in response to the updated classifier feature vector.

20. A non-transitory computer-readable medium comprising instructions, that when read by a processor, cause the processor to perform:
acquiring a user system architecture request comprising conceptual system architecture data associated with the target system requirements comprising architecture mechanisms and a plurality of architecture view points from the at least one user-entity node;
parsing the user system architecture request to extract a plurality of key classifying features;
querying a local database to retrieve local historical system architecture's correlation sets-related data based on the plurality of key classifying features;
generating at least one classifier feature vector based on the plurality of the key classifying architecture mechanism features and the local historical system architecture's correlation sets-related data;
providing the at least one classifier feature vector to the ML module configured to generate an architecture predictive model for producing at least one architecture viewpoint-based parameter; and
ingesting the at least one architecture viewpoint-based parameter into an architecture correlation model configured to output a plurality of design correlation parameters for level of support of the architecture mechanisms of a given viewpoint from the plurality of the architecture viewpoints.
